(19) United States
(12) Patent Application Publication
(10) Pub. No.: US 2025/0229364 A1
(43) Pub. Date: Jul. 17, 2025

(54) LASER SCRIBING APPARATUS, EQUIPMENT, AND CONTROL METHOD THEREOF

(71) Applicant: HYMSON LASER TECHNOLOGY GROUP CO., LTD., Shenzhen (CN)

(72) Inventors: Taiqing MA, Shenzhen (CN); Yuhuai YANG, Shenzhen (CN); Jianye MIAO, Shenzhen (CN); Qirui HE, Shenzhen (CN); Xue ZHANG, Shenzhen (CN); Chuangming YU, Shenzhen (CN); Bin SHI, Shenzhen (CN); Shuai DENG, Shenzhen (CN)

(73) Assignee: HYMSON LASER TECHNOLOGY GROUP CO., LTD., Shenzhen (CN)

(21) Appl. No.: 18/792,316

(22) Filed: Aug. 1, 2024

Related U.S. Application Data
(63) Continuation of application No. PCT/CN2024/091209, filed on May 6, 2024.

(30) Foreign Application Priority Data
Jan. 11, 2024 (CN) 202410044084.2

(51) Int. Cl. B23K 26/364; B23K 26/70

(52) U.S. Cl. CPC B23K 26/364; B23K 26/704

(57) ABSTRACT

Disclosed are a laser scribing apparatus, an equipment and a control method thereof. The laser scribing apparatus includes: a light source configured to emit a laser, and a beam splitter unit including a beam splitter and a light control component, the beam splitter and the light control component are sequentially provided along the optical path of the laser, the beam splitter is configured to split the laser into multiple scribing beams, and the light control component is configured to control the multiple scribing beams to pass along a same path in sequence.

### CROSS-REFERENCE TO RELATED APPLICATIONS

This application is a continuation application of International Application No. PCT/CN2024/091209, filed on May 6, 2024, which claims priority to Chinese Patent Application No. 202410044084.2, filed on Jan. 11, 2024. The disclosures of the above-mentioned applications are incorporated herein by reference in their entireties.

### TECHNICAL FIELD

The present application relates to the technical field of scribing equipment manufacturing, and in particular to a laser scribing apparatus, a laser scribing equipment and a control method thereof.

### BACKGROUND

At present, some laser scribing equipment generally only uses a single beam of laser for scribing. However, it is difficult to control the scribing depth when using a single beam of laser. When encountering a work scenario required deeper scribing, the laser energy of a single beam of laser fluctuates greatly, resulting in poor consistency in the depth of scribing. In addition, the efficiency of single beam laser scribing is low, which affects production progress.

### SUMMARY

The present application is intended to address at least one of the technical problems existing in the related art.

In view of this, according to a first aspect, the present application provides a laser scribing apparatus, including: a beam splitter and a light control component, the beam splitter and the light control component can split the laser into multiple scribing beams, and the multiple scribing beams are used to scribing in sequence to obtain a deeper scribing depth, and to ensure the consistency of scribing, a higher scribing efficiency, and the smooth progress of production.

According to a second aspect, the present application also provides a laser scribing apparatus using the laser scribing apparatus as described above.

According to a third aspect, the present application also provides a control method of the laser scribing applied to the laser scribing equipment as described above.

In an embodiment, the laser scribing apparatus includes a light source and a beam splitter unit. The light source is configured to emit a laser, the beam splitter unit includes a beam splitter and a light control component, the beam splitter and the light control component are sequentially provided along an optical path of the laser, the beam splitter is configured to split the laser into multiple scribing beams, and the light control component is configured to control the multiple scribing beams to pass along a same path in sequence.

In an embodiment, the light control component includes a galvanometer and a field lens, and the galvanometer and the field lens are cooperated to enable the multiple scribing beams to pass along the same path in sequence.

In an embodiment, the laser scribing equipment includes: the laser scribing apparatus as described above.

In an embodiment, the laser scribing equipment includes: an unwinding apparatus, a rewinding apparatus and multiple laser scribing apparatuses, the unwinding apparatus and the rewinding apparatus are cooperated to unwind or rewind a material to be scribed, the multiple laser scribing apparatuses are provided between the unwinding apparatus and the rewinding apparatus, and are configured to scribe an outer wall of the material to be scribed.

In an embodiment, the multiple laser scribing apparatuses include: a first group of laser scribing apparatus and a second group of laser scribing apparatus, the first group of laser scribing apparatus is provided on one side of the material to be scribed, and the second group of laser scribing apparatus is provided on another side opposite to the material to be scribed.

In an embodiment, the first group of laser scribing apparatus is opposite to the second group of laser scribing apparatus, and the material to be scribed is guided by a guide roller to pass through the first group of laser scribing apparatus and the second group of laser scribing apparatus in sequence.

In an embodiment, a tension apparatus is provided between the unwinding apparatus and the laser scribing apparatus, and is provided between the laser scribing apparatus and the winding apparatus, and the tension apparatus is configured to tension the material to be scribed.

In an embodiment, the tension apparatus includes a connecting frame and two tensioning rollers, the material to be scribed is wound around the two tensioning rollers, and the two tensioning rollers move towards each other or move away from each other to adjust tension of the material to be scribed.

In an embodiment, a dust cleaning apparatus is provided between the unwinding apparatus and the laser scribing apparatus, and is provided between the laser scribing apparatus and the winding apparatus, and the dust cleaning apparatus is configured to clean the outer wall of the material to be scribed.

In an embodiment, the control method of a laser scribing, applied to the laser scribing equipment as described above, the multiple laser scribing apparatuses include a first group of laser scribing apparatus and a second group of laser scribing apparatus, the material to be scribed is provided with a first area and a second area, and the method includes:
controlling the unwinding apparatus and the rewinding apparatus to pull the material to be scribed, to make the first group of laser scribing apparatus align with the first area and make the first group of laser scribing apparatus scribe on the first area;
controlling the unwinding apparatus and the rewinding apparatus to pull the material to be scribed, to make the first group of laser scribing apparatus skip the first area and make the second group of laser scribing apparatus align with the second area; and
controlling the second group of laser scribing apparatus scribe on the second area.

According to the laser scribing apparatus provided by the embodiment of the first aspect of the present application, there are at least the following beneficial effects: when the laser scribing apparatus is used to scribing the outer wall of the material to be scribed, the laser emitted by the light source passes through the beam splitter and the light control component in sequence. When passing through the beam splitter, the laser is divided into multiple scribing beams and then injected into the light control component. The light control component can control the multiple scribing beams so that the multiple scribing beams sequentially scribe on the outer wall of the material to be scribed along the same path. Each scribing beam can scribe a line of a certain depth when passing through the outer wall of the material to be scribed. After the multiple scribing beams sequentially scribe along the same path, the depth of the scribed line accumulates sequentially, so that a deeper line can be scribed on the outer wall of the material to be scribed. Since the laser is divided into multiple scribing beams during the scribing process, the energy fluctuation of the multiple scribing beams is small, so the consistency of the depth of the scribing is better. In addition, the multiple scribing beams scribing sequentially can improve the scribing efficiency and can ensure the smooth progress of the production.

According to the laser scribing equipment provided in the second aspect of the present application, there are at least the following beneficial effects: a beam splitter and a light control component can be used to split the laser into multiple scribing beams, and the multiple scribing beams are used to scribing in sequence to obtain a deeper scribing depth, and to ensure the consistency of scribing, a higher scribing efficiency, and the smooth progress of production.

According to the control method provided in the third aspect of the present application, there are at least the following beneficial effects: two groups of laser scribing apparatus scribing on the material to be scribed at the same time can ensure a high scribing efficiency, which is conducive to ensuring the smooth progress of production.

Additional aspects and advantages of the present application will be given in part in the description below, and in part will become apparent from the description below, or will be learned through the practice of the present application.

### BRIEF DESCRIPTION OF THE DRAWINGS

Additional aspects and advantages of the present application will become apparent and easily understood from the description of the embodiments in conjunction with the following drawings.

FIG. 1 is an overall schematic view of a laser scribing apparatus according to an embodiment of the present application.

FIG. 2 is a schematic view of an optical path of the laser scribing apparatus according to an embodiment of the present application.

FIG. 3 is a schematic view of a scribing beam and a scribing depth of the laser scribing apparatus according to an embodiment of the present application.

FIG. 4 is an overall schematic view of a laser scribing equipment according to an embodiment of the present application.

FIG. 5 is a schematic flowchart of a control method of a laser scribing according to an embodiment of the present application.

### DETAILED DESCRIPTION OF THE EMBODIMENTS

The embodiments of the present application are described in detail below, and examples of the embodiments are shown in the drawings, where the same or similar reference signs throughout represent the same or similar elements or elements with the same or similar functions. The embodiments described below with reference to the drawings are exemplary and are only used to explain the present application, and cannot be understood as limiting the present application.

In the description of the present application, it should be understood that the directions or positional relationships indicated by the description of the orientation, such as up, down, front, back, left, right, etc., are based on the directions or positional relationships shown in the drawings, which are only for the convenience of describing the present application and simplifying the description, and do not indicate or imply that the apparatus or element referred to must have a specific orientation, be constructed and operated in a specific orientation, and therefore cannot be understood as limiting the present application.

In the description of the present application, if there is a description of the first and the second, it is only for the purpose of distinguishing the technical features, and cannot be understood as indicating or implying the relative importance or implicitly indicating the number of the indicated technical features or implicitly indicating the order of the indicated technical features.

In the description of the application, unless otherwise clearly defined, terms such as setting, installing, connecting, etc. should be understood in a broad sense, and technicians in the relevant technical field can reasonably determine the specific meanings of the above terms in the application based on the specific content of the technical solution.

In the field of new energy lithium battery technology, in order to meet the requirements of battery charging and discharging time, it is necessary to perform pole sheet scribing before cleaning the pole sheet coil to meet specific process requirements. At present, some laser scribing equipment generally only uses a single beam of laser for scribing. However, it is difficult to control the scribing depth when using a single beam of laser. When encountering a work scenario required deeper scribing, the laser energy of a single beam of laser fluctuates greatly, resulting in poor consistency in the depth of scribing. In addition, the efficiency of single beam laser scribing is low, which affects production progress.

To solve the above problem, in an embodiment, the present application provides a laser scribing apparatus 100, the laser scribing apparatus 100 can divide the laser into multiple scribing beams by using a beam splitter 120 and a light control component 130, and the multiple scribing beams are used to scribing in sequence to obtain a deeper scribing depth, and to ensure the consistency of scribing, a higher scribing efficiency, and the smooth progress of production. The specific structure and function of the laser scribing device 100 provided in the embodiment of the present application will be further explained below with reference to text and drawings.

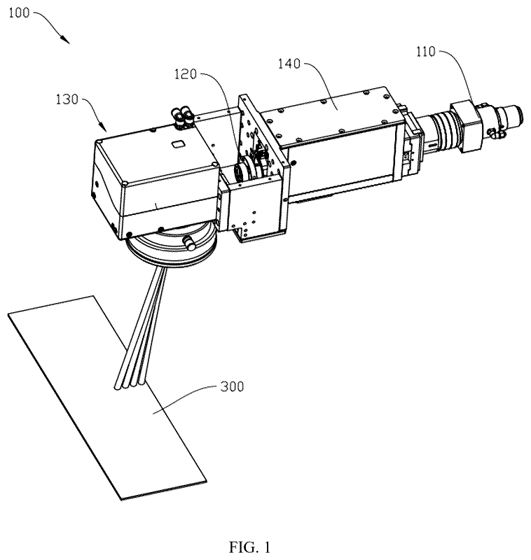

As shown in FIG. 1 to FIG. 3, a laser scribing apparatus 100 including: a light source 110 and a beam splitter unit, the light source 110 is configured to emit a laser; the beam splitter unit includes a beam splitter 120 and a light control component 130, the beam splitter 120 and the light control component 130 are sequentially provided along an optical path of the laser. When the laser emitted by the light source 110 passes through the beam splitter 120, the beam splitter 120 can split the laser into multiple scribing beams, and the light control component 130 is configured to control the multiple scribing beams so that the multiple scribing beams pass along a same path in sequence.

In an embodiment, when the laser scribing apparatus 100 is used to scribing the outer wall of the material to be scribed 300, the laser emitted by the light source passes through the beam splitter 120 and the light control component 130 in sequence. When passing through the beam splitter 1120, the laser is divided into multiple scribing beams and then injected into the light control component 130. The light control component 130 can control the multiple scribing beams so that the multiple scribing beams sequentially scribe on the outer wall of the material to be scribed 300 along the same path. Each scribing beam can scribe a line of a certain depth when passing through the outer wall of the material to be scribed 300. After the multiple scribing beams sequentially scribe along the same path, the depth of the scribed line accumulates sequentially, so that a deeper line can be scribed on the outer wall of the material to be scribed 300. Since the laser is divided into multiple scribing beams during the scribing process, the energy fluctuation of the multiple scribing beams is small, so the consistency of the depth of the scribing is better. In addition, the multiple scribing beams scribing sequentially can improve the scribing efficiency and can ensure the smooth progress of the production.

In an embodiment, the beam splitter 120 can divide the laser into 3, 4, 8, or 20 scribing beams, etc., and the number of scribing beams is not limited here.

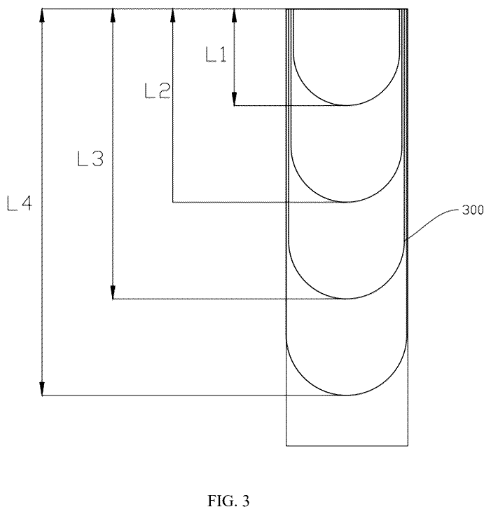

As shown in FIG. 3, when the laser scribing apparatus 100 is used to scribing the material to be scribed 300 (pole sheet coil), the preset scribing depth is 16 microns. At this time, the beam splitter 120 can be used to divide the laser into 4 scribing beams. The scribing depth of each scribing beam is 4 microns. When the 4 scribing beams are scribing along the same path, the first scribing beam completes the scribing at a depth of 4 microns (L1). The second scribing beam completes the scribing at a depth of 8 microns (LI to L2). The third scribing beam completes the scribing at a depth of 12 microns (L2 to L3). The fourth scribing beam completes the scribing at a depth of 16 microns (L3 to L4). When multiple scribing beams are used to scribing in sequence, the scribing depth and the energy fluctuation are small. Therefore, the consistency of the scribing depth is better. Multiple scribing beams are used to scribe in sequence conducive to improving the scribing efficiency.

During the scribing process, multiple scribing beams are simultaneously irradiated to the material to be scribed 300 and scribing the material to be scribed 300. The scribing process is beneficial to improving the scribing efficiency. During the scribing process, multiple scribing beams sequentially pass through the same path, and the distance between adjacent scribing beams is maintained between 0.1 millimeters and 0.2 millimeters. The distance between adjacent scribing beams can be modified according to actual processing requirements. The scribing depth of the scribing beam is not limited to 4 microns, but can also be 5 microns, 6 microns, etc., and the scribing depth of the scribing beam is not limited here.

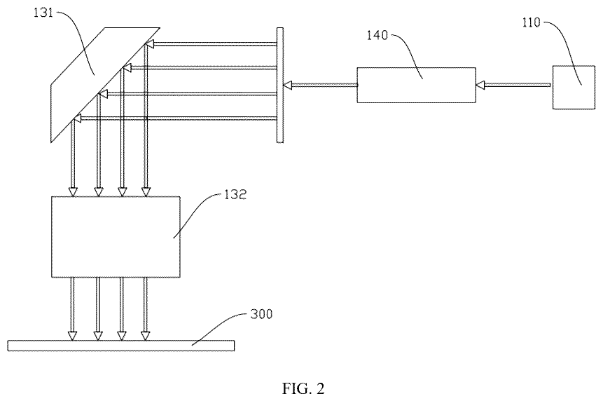

As shown in FIG. 1 and FIG. 2, in an embodiment, the light control component 130 includes a galvanometer 131 and a field lens 132. Firstly, beam splitter 120 divide the laser into multiple scribing beams by the beam splitter. Secondly, the galvanometer 131 adjusts the offset direction so that the multiple scribing beams can pass along the same path in sequence. Thirdly, the field lens 132 focus the multiple scribing beams onto the material to be scribed 300 and perform scribing.

As shown in FIG. 1 and FIG. 2, the beam splitter unit further includes a collimator 140, the collimator 140 is provided between the light source 110 and the beam splitter 120, and the collimator 140 can adjust the accuracy of the laser emitted from the light source 110 entering the beam splitter 120.

In an embodiment, the present application also provides a laser scribing equipment, the laser scribing equipment including the aforementioned laser scribing apparatus.

In an embodiment, the beam splitter 120 cooperates with the light control component 130 to split the laser into multiple scribing beams, and the multiple scribing beams are used for scribing in sequence. While obtaining a deeper scribing depth, the consistency of the scribing and the higher scribing efficiency can be ensured, which is conducive to ensuring the smooth progress of the production process.

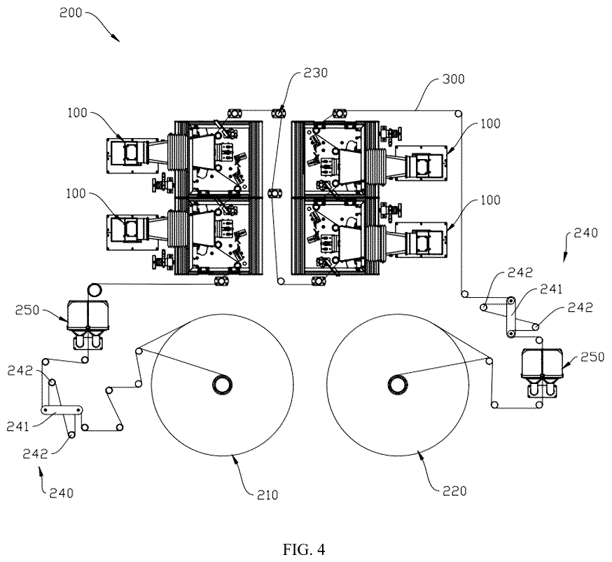

In an embodiment, as shown in FIG. 4, a laser scribing equipment 200 includes an unwinding apparatus 210, a rewinding apparatus 220 and multiple laser scribing apparatus 100. The unwinding apparatus 210 cooperates with the rewinding apparatus 220 to unwind or rewind the material to be scribed 300. Multiple laser scribing apparatus 100 are provided between the unwinding apparatus 210 and the rewinding apparatus 220 used for scribing the outer wall of the material to be scribed 300. With this setting, efficient scribing can be achieved.

The laser scribing apparatus 100 can be provided with 2, 3, 4, etc., and the quantity of the laser scribing apparatus 100 is not limited here.

For example, when there are two laser scribing apparatus 100 and the two laser scribing apparatus 100 are distributed on the same side of the material to be scribed 300, the two laser scribing apparatus 100 simultaneously scribe the outer wall of the material to be scribed 300, and the scribing efficiency is high.

In an embodiment, as shown in FIG. 4, multiple laser scribing apparatus 100 include a first group of laser scribing apparatus and a second group of laser scribing apparatus, the first group of laser scribing apparatus is provided on one side of the material to be scribed 300, and the second group of laser scribing apparatus is provided on another side opposite to the material to be scribed 300. The cooperation between the two groups of laser scribing apparatuses 100 is conducive to improving the scribing efficiency.

In an embodiment, the number of laser scribing apparatus 100 in each group can be the same: the quantity of laser scribing apparatus 100 can be an even number, such as 2, 4, 8, etc. When the number of laser scribing apparatus 100 is 2, each group includes 1 laser scribing apparatus 100. When the number of laser scribing apparatus 100 is 4, each group includes 2 laser scribing apparatus 100. The number of laser scribing apparatus 100 in each group can be an odd number or an even number. The number of laser scribing apparatus 100 in each group also can be different, and the number of laser scribing apparatus 100 in each group is not limited here.

In an embodiment, when the laser scribing apparatus 100 is used to simultaneously scribing both sides of the material to be scribed 300, the scribing areas of the laser scribing apparatus 100 on both sides of the material to be scribed 300 are divided. For example, The laser scribing apparatus 100 on one side scribes within an area on the material 300 to be scribed, and leaves a blank area for the laser scribing apparatus 100 on another side to scribe later.

In an embodiment, as shown in FIG. 4, the first group of laser scribing apparatus is opposite to the second group of laser scribing apparatus. That is, the laser scribing apparatus 100 distributed on both sides of the material to be scribed are provided relatively and flush with each other. The material to be scribed 300 is guided by the guide rollers 230 to pass through the first group of laser scribing apparatus 100 and the second group of laser scribing apparatus 100 in sequence. The entire laser scribing equipment 200 has a highly compact, which is beneficial to reducing the volume of the laser scribing equipment 200.

In an embodiment, as shown in FIG. 4, the laser scribing equipment 200 further includes a tension apparatus 240, the tension apparatus 240 is provided between the unwinding apparatus 210 and the laser scribing apparatus 100, and is provided between the laser scribing apparatus 100 and the winding apparatus 220, and the tension apparatus 240 is configured to tension the material to be scribed.

When the material to be scribed 300 passes through the tension apparatus 240 provided between the unwinding apparatus 210 and the laser scribing apparatus 100, the material to be scribed 300 can remain tensioned, so that the depth of the laser scribing apparatus 100 on the material to be scribed 300 remains consistent. When the material to be scribed 300 passes through the tension apparatus 240 provided between the laser scribing apparatus 100 and the winding apparatus 220, the material to be scribed 300 can remain tensioned, so that the winding apparatus 220 can be wound up.

In an embodiment, as shown in FIG. 4, the tension apparatus 240 includes a connecting frame 241 and two tensioning rollers 242, and the material to be scribed 300 is wound around the two tensioning rollers 242. The two tensioning rollers 242 move towards each other or move away from each other to adjust the tension of the material to be scribed 300. The tension of the material to be scribed 300 can be adjusted by adjusting the distance between the two tensioning rollers 242, and the adjustment method is simple and reliable.

In an embodiment, as shown in FIG. 4, the laser scribing equipment includes a dust cleaning apparatus 250, the dust cleaning apparatus 250 is provided between the unwinding apparatus 210 and the laser scribing apparatus 100. When the material to be scribed 300 passes through the dust cleaning apparatus 250 provided between the unwinding apparatus 210 and the laser scribing apparatus 100, impurities remaining on the outer wall of the material to be scribed 300 during production or transportation are removed, so that the depth of the laser scribing apparatus 100 on the material to be scribed 300 remains consistent. And the dust cleaning apparatus is also provided between the laser scribing apparatus and the winding apparatus. When the material to be scribed 300 passes through the dust cleaning apparatus 250 provided between the laser scribing apparatus 100 and the winding apparatus 220, the dust cleaning apparatus 250 can clear the material powder generated during the scribing process, so as to ensure the cleanliness of the outer wall of the material wound up by the winding apparatus 220.

In an embodiment, the present application also provides a control method of the laser scribing, applied to the aforementioned laser scribing equipment 200. The multiple laser scribing apparatuses 100 include a first group of laser scribing apparatus and a second group of laser scribing apparatus. The material to be scribed 300 is provided with a first area and a second area.

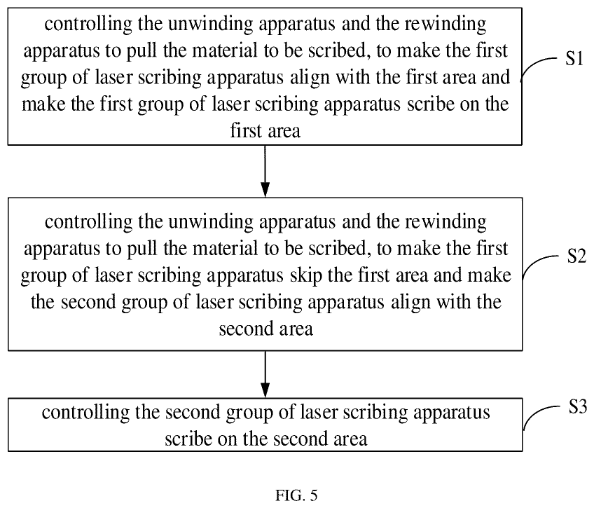

As shown in FIG. 5, the control method of the laser scribing includes:
S1, controlling the unwinding apparatus 210 and the rewinding apparatus 220 to pull the material to be scribed 300, to make the first group of laser scribing apparatus 100 align with the first area and make the first group of laser scribing apparatus 100 scribe on the first area;
S2, controlling the unwinding apparatus 210 and the rewinding apparatus 220 to pull the material to be scribed 300, to make the first group of laser scribing apparatus 100 skip the first area and make the second group of laser scribing apparatus 100 align with the second area; and
S3, controlling the second group of laser scribing apparatus 100 scribe on the second area.

The two groups of laser scribing apparatus 100 scribing the material to be scribed 300 at the same time can ensure a high scribing efficiency, which is conducive to ensuring the smooth progress of production.

The quantity of laser scribing apparatus 100 can be an even number, such as 2, 4, 8, etc. When the number of laser scribing apparatus 100 is 2, the first group of laser scribing apparatus includes 1 laser scribing apparatus 100, and the second group of laser scribing apparatus includes 1 laser scribing apparatus 100. When the number of laser scribing apparatus 100 is 4, each group of laser scribing apparatus includes 2 laser scribing apparatus 100. The number of laser scribing apparatus 100 in each group can be an odd number or an even number; the number of laser scribing apparatus 100 in each group of laser scribing apparatus can be the same or different, and the number of laser scribing apparatus 100 in each group of laser scribing apparatus is not limited here.

Two groups of laser scribing apparatus 100 can be provided on both the front and back sides of the material to be scribed 300, so as to scribe both the front and back sides of the material to be scribed 300. It should be noted that the area of the material to be scribed 300 by the first group of laser scribing apparatus 100 may be considered as the first area, and the area of the material to be scribed 300 by the second group of laser scribing apparatus 100 may be considered as the second area, and the positions of the first area and the second area can be configured according to the actual production process.

The embodiments of the present application are described in detail above in conjunction with the drawings. The above embodiments are only used to illustrate the technical solution of the present application, rather than to limit it. The present application is not limited to the above embodiments. Various changes can be made within the knowledge scope of ordinary technicians in the relevant technical field without departing from the purpose of the present application.

What is claimed is:

1. A laser scribing apparatus, comprising:
a light source configured to emit a laser; and
a beam splitter unit comprising a beam splitter and a light control component; wherein:
the beam splitter and the light control component are sequentially provided along an optical path of the laser, the beam splitter is configured to split the laser into multiple scribing beams, and the light control component is configured to control the multiple scribing beams to pass along a same path in sequence.

2. The laser scribing apparatus of claim 1, wherein the light control component comprises a galvanometer and a field lens, and the galvanometer and the field lens are cooperated to enable the multiple scribing beams to pass along the same path in sequence.

3. A laser scribing equipment, comprising the laser scribing apparatus of claim 1.

4. The laser scribing equipment of claim 3, comprising:
an unwinding apparatus;
a rewinding apparatus; and
multiple laser scribing apparatuses, wherein:
the unwinding apparatus and the rewinding apparatus are cooperated to unwind or rewind a material to be scribed, the multiple laser scribing apparatuses are provided between the unwinding apparatus and the rewinding apparatus, and are configured to scribe an outer wall of the material to be scribed.

5. The laser scribing equipment of claim 4, wherein the multiple laser scribing apparatuses comprise a first group of laser scribing apparatus and a second group of laser scribing apparatus, the first group of laser scribing apparatus is provided on one side of the material to be scribed, and the second group of laser scribing apparatus is provided on another side opposite to the material to be scribed.

6. The laser scribing equipment of claim 5, wherein the first group of laser scribing apparatus is opposite to the second group of laser scribing apparatus, and the material to be scribed is guided by a guide roller to pass through the first group of laser scribing apparatus and the second group of laser scribing apparatus in sequence.

7. The laser scribing equipment of claim 4, wherein a tension apparatus is provided between the unwinding apparatus and the laser scribing apparatus, and is provided between the laser scribing apparatus and the winding apparatus, and the tension apparatus is configured to tension the material to be scribed.

8. The laser scribing equipment of claim 7, wherein the tension apparatus comprises a connecting frame and two tensioning rollers, the material to be scribed is wound around the two tensioning rollers, and the two tensioning rollers move towards each other or move away from each other to adjust tension of the material to be scribed.

9. The laser scribing equipment of claim 4, wherein a dust cleaning apparatus is provided between the unwinding apparatus and the laser scribing apparatus, and is provided between the laser scribing apparatus and the winding apparatus, and the dust cleaning apparatus is configured to clean the outer wall of the material to be scribed.

10. A control method of a laser scribing, applied to the laser scribing equipment of claim 4, wherein the multiple laser scribing apparatuses comprise a first group of laser scribing apparatus and a second group of laser scribing apparatus, the material to be scribed is provided with a first area and a second area, and the method comprises:
controlling the unwinding apparatus and the rewinding apparatus to pull the material to be scribed, to make the first group of laser scribing apparatus align with the first area and make the first group of laser scribing apparatus scribe on the first area;
controlling the unwinding apparatus and the rewinding apparatus to pull the material to be scribed, to make the first group of laser scribing apparatus skip the first area and make the second group of laser scribing apparatus align with the second area; and
controlling the second group of laser scribing apparatus scribe on the second area.
